(19) United States
(12) Patent Application Publication
(10) Pub. No.: US 2013/0332374 A1
(43) Pub. Date: Dec. 12, 2013

(54) FRAUD PREVENTION FOR REAL ESTATE TRANSACTIONS

(71) Applicants: Scott Hartnett, Miami, FL (US); John Romney, Miami, FL (US); Richard Xiques, Miami, FL (US)

(72) Inventors: Scott Hartnett, Miami, FL (US); John Romney, Miami, FL (US); Richard Xiques, Miami, FL (US)

(21) Appl. No.: 13/492,851

(22) Filed: Jun. 9, 2012

(51) Int. Cl. G06Q 50/16

(52) U.S. Cl. 705/313

(57) ABSTRACT

A method on a server for detecting fraud in a real estate transaction involving a real estate interest is provided. Parties to the real estate transaction are defined and parties may register with the server. The server receives a first unique identifier for the first party, a unique identifier for the real estate interest, a first purchase amount for the real estate interest, a second unique identifier for the second party, and a second purchase amount. The server compares the first purchase amount with the second purchase amount and the server may transmit a request for a notarization document. The server receives the notarization document, including a third purchase amount. The server compares the first purchase amount with the third purchase amount. Then, the server stores an indicator that the real estate transaction has been vetted.

### CROSS-REFERENCE TO RELATED APPLICATIONS

This utility patent application claims priority to utility patent application Ser. No. 12/917,182 entitled “Real Estate Fraud Prevention Method and Device,” filed Nov. 1, 2010, which is a continuation in part of utility patent application Ser. No. 12/815,056 entitled “Real Estate Fraud Prevention Method and Device,” filed Jun. 14, 2010, which claims priority to provisional application No. 61/187,700, filed Jun. 17, 2009. The subject matter of patent application Ser. Nos. 12/917,182, 12/815,056 and 61/187,700 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to real estate industries and, more specifically, to processes for detecting fraud in real estate transactions over telecommunications networks.

### BACKGROUND

Various methods exist for perpetrating fraud in real estate transactions. One common fraudulent method includes the doctoring of the original purchase contract. This method, usually perpetrated by the purchaser of the property, occurs as follows: the purchaser and seller sign a purchase contract for a given purchase price, but the purchaser gives his lender a fraudulent purchase contract that lists a higher purchase price. Once the real estate transaction is completed, the purchase pockets the difference.

Another common method of perpetrating fraud in real estate transactions involves the use of straw buyers, fictitious buyers or unwitting buyers. This method entails the use of the identity and credit history (sometimes stolen) of a silent, non-existent or unwitting person who has no intention to live in or take care of the subject property. The perpetrators eventually make off with the proceeds of the loan.

Yet another known method of committing fraud in real estate transactions involves the use of fake or doctored documents to induce the lender to issue a loan to purchase a subject property. Loan applications, for example, often contain purposefully inaccurate information, such as inflated income, in order to meet the requirements for a loan. Bank statements and other financial documents, which are typically requested to substantiate an income statement, are often falsified to appear as if the borrower owns more assets of receives a higher salary.

Current fraud detection solutions are not adept at catching the common fraudulent methods described above. Neither are conventional solutions proficient in detecting the participation of individuals with known or suggested ties to previous fraudulent activities. It is common for fraudsters to perpetrate multiple, sometimes dozens, of fraudulent real estate transactions before they are caught. But current methods of detecting fraud in real estate transactions do not have a mechanism for identifying the participation of known fraudsters in a real estate transaction before the transaction commences.

Therefore, a need exists for improvements over the prior art, and more particularly for more efficient and accurate methods and systems for detecting fraud in real estate transactions.

### SUMMARY

A method, system and computer program product that allows for detecting fraud in a real estate transaction involving a real estate interest is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a method for detecting fraud in a real estate transaction involving a real estate interest is provided that solves the above-described problems regarding fraud detection. A server receives, via a communications network, definition data for each of a plurality of parties to the real estate transaction and allows parties to the real estate transaction to register with the server. Next, the server receives a first transaction data from a first party to the real estate transaction, wherein the first transaction data includes at least a unique identifier for the real estate interest and a first purchase amount for the real estate interest. Next, the server receives, via the communications network, a second transaction data from a second party to the real estate transaction, wherein the second transaction data includes at least the unique identifier for the real estate interest and a second purchase amount for the real estate interest.

Next, the server compares the first purchase amount with the second purchase amount, and if the two values are not identical, the server transmits a request to review the real estate transaction. If certain ones of the plurality of parties do not undergo registering, the server transmits a request for a notarization document associated with the real estate interest. Responsive to transmitting the request the server receives an image of the notarization document associated with the real estate interest, wherein the notarization document includes at least a third purchase amount, a third unique identifier for the first party and a fourth unique identifier for the second party. Next the server compares the first unique identifier with the third unique identifier, the second unique identifier with the fourth unique identifier, and the first purchase amount with the third purchase amount. If the first unique identifier is identical to third unique identifier, the second unique identifier is identical to the fourth unique identifier, and the first purchase amount is identical to the third purchase amount, the server stores an indicator that the real estate transaction has been vetted.

### BRIEF DESCRIPTION OF THE DRAWINGS

The accompanying drawings, which are incorporated in and constitute a part of this disclosure, illustrate various example embodiments. In the drawings:

FIG. 1 is a block diagram of an operating environment that supports fraud detection processes for real estate transactions, according to an example embodiment;

FIG. 2 is a diagram showing the data flow of a fraud detection processes for real estate transactions, according to an example embodiment;

FIG. 3 is a flow chart of a method for detecting fraud for real estate transactions, according to an example embodiment;

FIG. 4 is a flow chart of a method for performing document examination routines for fraud detection processes for real estate transactions, according to an example embodiment;

FIG. 5 is a flow chart of a method for searching derogatory information for fraud detection processes for real estate transactions, according to an example embodiment; and

FIG. 6 is a block diagram of a system including a computing device, according to an example embodiment.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Disclosed methods provide for detecting fraud in a real estate transaction. The systems and methods of the present invention provide an automated and seamless process for detecting the perpetration of common methods of real estate fraud. The systems and methods of the present invention improve over the prior art by detecting the use and/or submission of a purchase contract with a purchase price that is different from the purchase price of the actual purchase contract signed by the buyer and seller. The present invention is further adept at detecting the use of straw buyers, fictitious buyers or unwitting buyers by requiring an in-person notarization of all parties to a real estate transaction. Further, the systems and methods of the present invention employ a document analysis process that detects the doctoring, falsification or corruption of pertinent loan documents, such as loan applications, bank statement and financial documents. Lastly, the present invention improves over the prior art by providing a mechanism for identifying the participation of known fraudsters in a real estate transaction before the transaction commences.

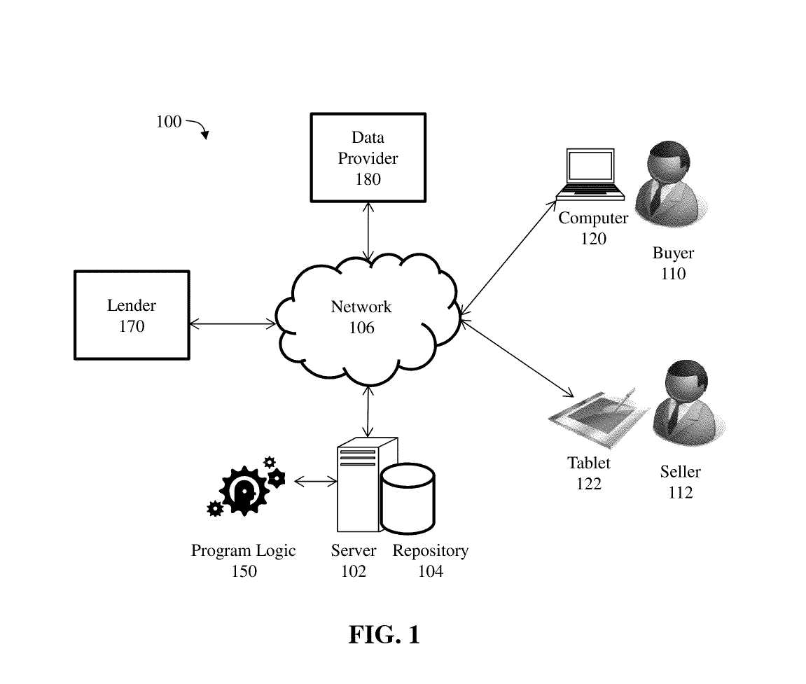

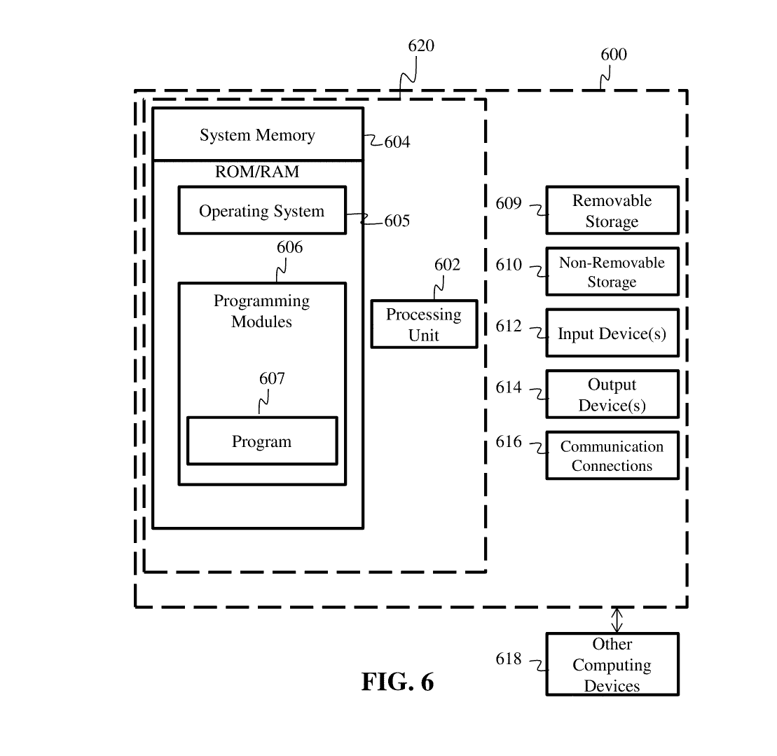

FIG. 1 is a block diagram of an operating environment 100 that supports fraud detection processes for real estate transactions, according to an example embodiment. The environment 100 may comprise multiple client computers 120, 122 and a server 102 communicating via a communications network 106. Each of the client computers 120, 122 and server 102 may be connected either wirelessly or in a wired or fiber optic form to the communications network 106. Client computers 120, 122 and server 102 may each comprise a computing device 600, described below in greater detail with respect to FIG. 6. FIG. 1 shows that client computers 120, 122 may comprise mobile computing devices such as cellular telephones, smart phones, laptops, tablet computers, or other computing devices such as desktop computers, game consoles, or the like. Communications network 102 may be a packet switched network, such as the Internet, or any local area network, wide area network, enterprise private network, cellular network, phone network, mobile communications network, or any combination of the above.

Environment 100 may be used when multiple real estate transaction parties 110, 112 engage in a real estate transaction involving a real estate interest, which may be one or more houses, parcels of land, property, condominiums, development rights, etc. (hereinafter referred to as an “interest” or a “real estate interest”). Party 110 may represent a buyer of the real estate interest, while party 112 may represent the seller. Lender 170 refers to a bank, financial institution, liquidity provider, etc., which provides financing, a mortgage, money, a loan and/or funds to the buyer 110 for the purchase of the real estate interest. The lender 170 may also be one or more individuals, corporations, etc. Data provider 180 refers to a data collector, a public records aggregator, a background check entity, a record searcher, or other provider of data pertaining to individuals, namely criminal background data.

Note that although FIG. 1 shows only two parties 110, 112, environment 100 supports the participation of additional parties, such as real estate agents, real estate brokers, title companies, real estate attorneys, notaries, multiple buyers, multiple sellers, multiple lenders, etc.

FIG. 1 further shows that server 102 includes a database or repository 104, which may be a relational database comprising a Structured Query Language (SQL) database stored in a SQL server. Client computers 120, 122 may also each include their own database. The repository 104 serves data from a database, which is a repository for data used by server 102 and the client computers during the course of operation of the invention. The database 104 may include, for example, a user record for each user 110, 112. A user record may include: contact/identifying information for a party (such as name, address, phone number, email address, etc.), a unique identifier for a party, social security number, date of birth, tax identification number, certification number, license number, a list of permissions for the user, login names, passwords, PINs, a role definition defining the role the party will play in the real estate transaction, etc. A user record may also be associated with one or more documents or document images that have been uploaded by the user.

FIG. 1 shows an embodiment of the present invention wherein networked computing devices 120, 122 interact with server 102 and repository 104 over the network 106. Server 102 includes a software engine that delivers applications, data, program code and other information to networked computing devices 120, 122. It should be noted that although FIG. 1 shows only two networked computing devices 120, 122, the system of the present invention supports any number of networked computing devices connected via network 106.

Server 102 includes program logic 150 comprising computer source code, scripting language code or interpreted language code that is compiled to produce executable file or computer instructions that perform various functions of the present invention. In another embodiment, program logic 150 may be distributed among more than one of server 102, computers 120, 122, or any combination of the above. In yet another embodiment, program logic 150 may comprise a programming module, as shown in FIG. 6.

Note that although server 102 is shown as a single and independent entity, in one embodiment of the present invention, the functions of server 102 may be integrated with another entity, such as one of the client computers or one or more of the entities 170, 180. Further, server 102 and its functionality, according to a preferred embodiment of the present invention, can be realized in a centralized fashion in one computer system or in a distributed fashion wherein different elements are spread across several interconnected computer systems.

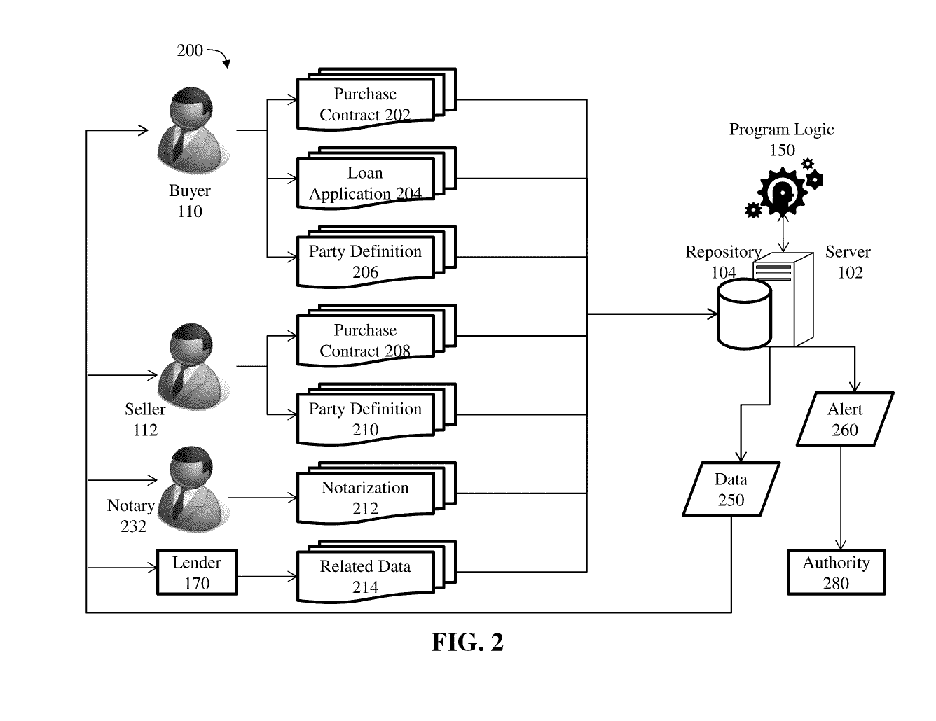

FIG. 2 is a diagram showing the data flow 200 of a fraud detection processes for real estate transactions, according to an example embodiment. FIG. 2 depicts the transfer of data to and from different parties to the real estate transaction, such as server 102. FIG. 2 shows that buyer 110 may provide a signed purchase contract 202 to the database 104. The purchase contract 202 may be provided in various formats, such as Portable Document Format (PDF), TIFF, JPEG, etc. The purchase contract 202 may also be provided as a document image, referring to a digital image of a document, which is a numeric representation (normally binary) of a two-dimensional image. The document image may be of vector or raster type, also called a bitmap image.

Note that the purchase contract 202 includes various data surrounding the real estate transaction, including the identity of the parties, the purchase price of the real estate interest, the identity of the real estate interest (such as the property location, folio number, property identification number, description, etc.), attributes about the real estate interest, such as square footage and type, and other contract terms. The buyer 110 may further provide the data 202 by entering data into a graphical user interface (GUI), such as entering voice or text into text fields of a web page.

The buyer 110 may also provide a loan application 204 and supporting documents, such as bank statement, financial documents, etc. The buyer 110 may provide the data of the loan application 204 as documents in various formats or as document images. The buyer 110 may provide the data of the loan application 204 and the supporting documents by entering data into a GUI. Lastly, the buyer 110 may enter party definition data 206 for one or more of the parties to the real estate transaction, which may comprise any of the data of a user record, as defined above. In addition to the buyer 110 and seller 112, party definition data 206 may include data about additional parties, such as real estate agents, real estate brokers, title companies, real estate attorneys, notaries, etc. The buyer 110 may provide the party definition data 206 by entering text or voice into a GUI.

Further, seller 112 may provide a signed purchase contract 208 to the database 104, similar to purchase contract 202. Also, the seller 112 may enter party definition data 210 for the parties to the real estate transaction, similar to data 206. The seller 112 may provide the party definition data 210 by entering text or voice into a GUI. Additionally, a notary 232 (or notarization entity) may enter a notarized document 212, such as a purchase contract signed and notarized by the buyer 110, seller 112 and notary 232. The notarized document 212 may be entered in various formats, including a document image. The notary 232 may further provide the data 212 by entering data into a GUI.

FIG. 2 also shows that lender 170 may provide data 214 related to the real estate transaction to the database 104. Data 214 may include any of the data related to the parties, the address of the subject property, the purchase price of the property, etc., such as the data defined in 202, 206, 208, 210 and 212.

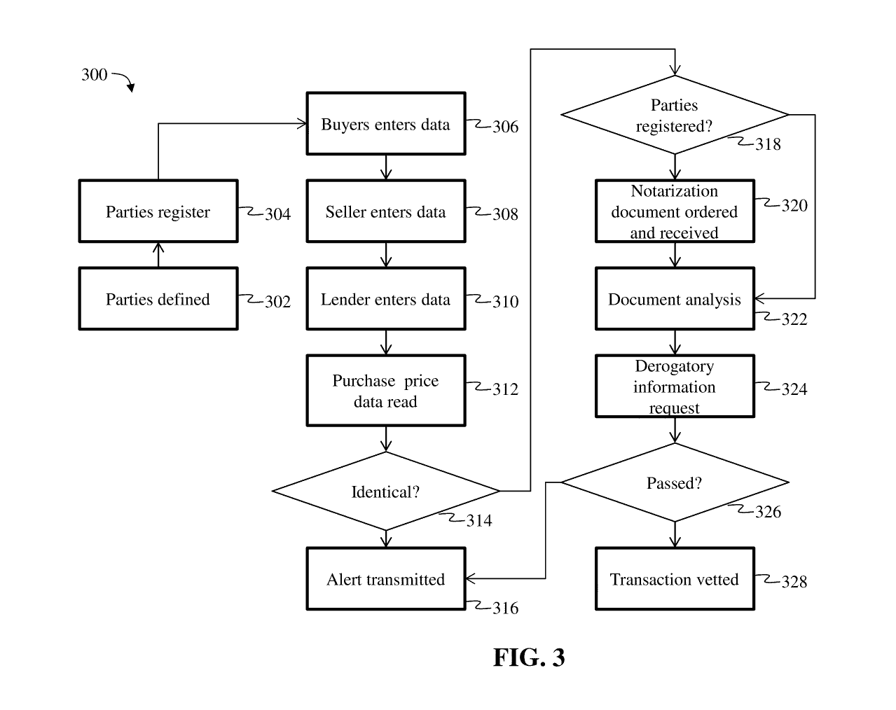

Finally, FIG. 2 further shows that server 102 transmits data 250 to the buyer 110, seller 112 and lender 170. The data 250 may include alerts, messages, reminders or the like, which are described in greater detail below with reference to FIGS. 3-5. FIG. 2 also shows that server 102 transmits an alert 260 to authority 280. The alert may be, for example, a message, a report, a suspicious activity report, etc. The alert 260 may include any of the data submitted to the server 102 in FIG. 2. A suspicious activity report may include a report made to an agency of the United States Department of the Treasury, regarding suspicious or potentially suspicious activity. A suspicious activity report may include detailed information about transactions that are or appear to be suspicious. In one embodiment, the alert 260 may be a message to an authority requesting that the real estate transaction be reviewed or specially scrutinized for irregularities or fraud. The circumstances leading to the transmission of an alert 260 are described in greater detail below with reference to FIGS. 3-5. The authority 280 may be an individual, a group entity, a corporate entity, a governmental entity, etc.

Note that any or all of the data submitted to the server 102 in FIG. 2 for a real estate transaction may be stored in one record in database 104 or stored in multiple records that are linked or associated with one another. The one or more records stored in database 104 for a particular real estate transaction may possess certain defined permissions that vary according to the user. For example, the seller 112 may have read access for the purchase contract 202 but the seller 112 may not have access to modify the purchase contract 202.

FIG. 3 is a flow chart of a method 300 for detecting fraud for real estate transactions, according to an example embodiment. FIG. 3 generally depicts the actions taken by each of the parties to a real estate transaction with regard to server 102. Method 300 may be implemented using one or more computing devices 600, as described in more detail below with respect to FIG. 6.

Method 300 starts with stage 302 wherein one or more of the parties to the real estate transaction are defined, such as by party data definition 206 or 210, via the actions of one or more parties to the real estate transaction. Stage 302 may further include the definition of one or more parties to the real estate transaction that must register within a predefined period of time in order for the real estate transaction to be vetted. Additionally, as will be shown below, if certain parties to the real estate transaction do not register within the predefined period of time, an alert may be transmitted.

Next, in stage 304, one or more of the parties to the real estate transaction register with server 102. The process of registering may comprise a party logging into server 102 and providing one or more of the data of a user record, as defined above, and the provision, by server 102, of login information, such as a user name and password. Subsequently, the server 102 logs the registration of each of the parties and compares it to the list of the one or more parties to the real estate transaction that must register in order for the real estate transaction to be vetted (as defined in step 302 above).

In stage 306, the buyer 110 may enter purchase contract 202, loan application 204 (and related documentation), and party data definition 206 into the database 104 of server 102. Next, in stage 308, the seller 112 may enter purchase contract 208, and party data definition 210 into the database 104 of server 102. In stage 310, the lender 170 enters data 214 into the database 104 of server 102.

In the next stage 312, the program logic 150 of server 102 reads a purchase price from the purchase contract 202 and reads a purchase price from the purchase contract 208. The purchase price of purchase contract 202 and purchase contract 208 may be extracted in a variety of ways. First, a party, such as buyer 110 and seller 112 may have previously entered the purchase price data as text, as shown in data flow 200. Second, if purchase contract 202 and purchase contract 208 are document images, then the program logic 150 of server 102 may perform an optical character recognition (OCR) process to convert the files to a character-based document image. Subsequently, the program logic 150 of server 102 may perform a text string search to find the purchase price in the character-based document images. An example of a text string search is the regular expression “purchase price $*”. In computing, a regular expression provides a concise and flexible means to match (i.e., specify and recognize) strings of text, such as particular characters, words, or patterns of characters.

In one embodiment of the present invention, the stage 312 is fully automated and performed by program logic 150 of server 102. In another embodiment of the present invention, the stage 312 is partially automated and performed by program logic 150 of server 102 in conjunction with the aid of an individual, such as buyer 110. In this embodiment, the buyer 110 may specify the area of the document image in which the purchase price is located or may highlight the purchase price in the document image.

In stage 314, the program logic 150 of server 102 compares the purchase price from the purchase contract 202 with the purchase price from the purchase contract 208. If the result of the comparison is that the two values are identical, then control flows to stage 318. If the result of the comparison is that the two values are not identical, then control flows to stage 316.

In stage 316, the program logic 150 of server 102 sends an alert to the authority 280, as defined above. The alert may contain any of the data entered by any of the parties, as shown in FIG. 2. In lieu of sending a alert, or in conjunction with this act, the program logic 150 of server 102 may send a message 250 (via email, SMS text, phone call, regular mail, etc.) alerting one or more of parties to the real estate transaction that aberrant data was found in the course of the real estate transaction and that the real estate transaction will not be moving forward.

In the next stage 318, the program logic 150 of server 102 reads the logs of the registration of each of the parties and compares it to the list of the one or more parties to the real estate transaction that must register in order for the real estate transaction to be vetted (as defined in step 302 above). If all of the necessary parties have registered with the server 102 within a predefined period of time, then control flows to step 322. If all of the necessary parties have not registered with the server 102 within the predefined period of time, then control flows to step 320.

In stage 320, the program logic 150 of server 102 sends a request for a notarization document and, in response to the request, receives a copy of the notarization document. A notarization document may comprise a copy of the purchase contract 202 or 208, which has been signed by the buyer 110 and seller 112 and notarized by the notary 232. Note that part of the notarization process may include an in-person verification of the identity of the buyer 110 and seller 112, as well as a signature by the notary 232 and the placement of certain data on the document by the notary 232, such as a seal and identity data of the buyer 110 and seller 112, such as drivers license information. The purpose of the notarization document is to establish the veracity of the information in the purchase contract 202 or 208, such as the purchase price, and to establish the identity and existence of the buyer 110 and seller 112.

In another embodiment of the present invention, stage 320 includes program logic 150 of server 102 determining contact information for a notary 232 within a vicinity of the real estate interest of the real estate transaction and transmitting a request, over the communications network 106, to the notary 232 requesting a notarization document associated with the real estate interest.

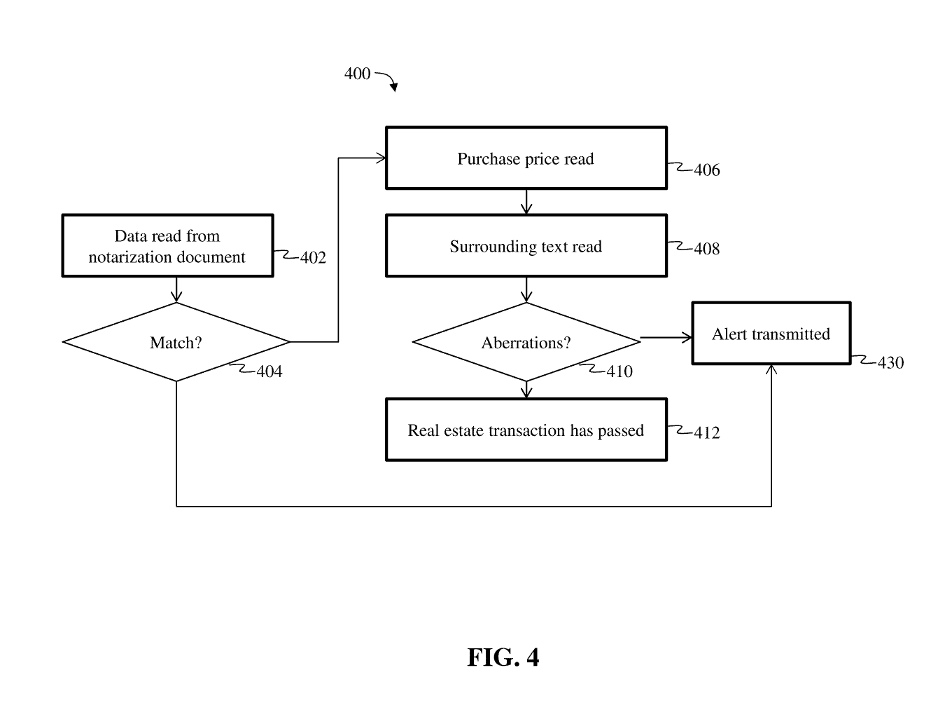

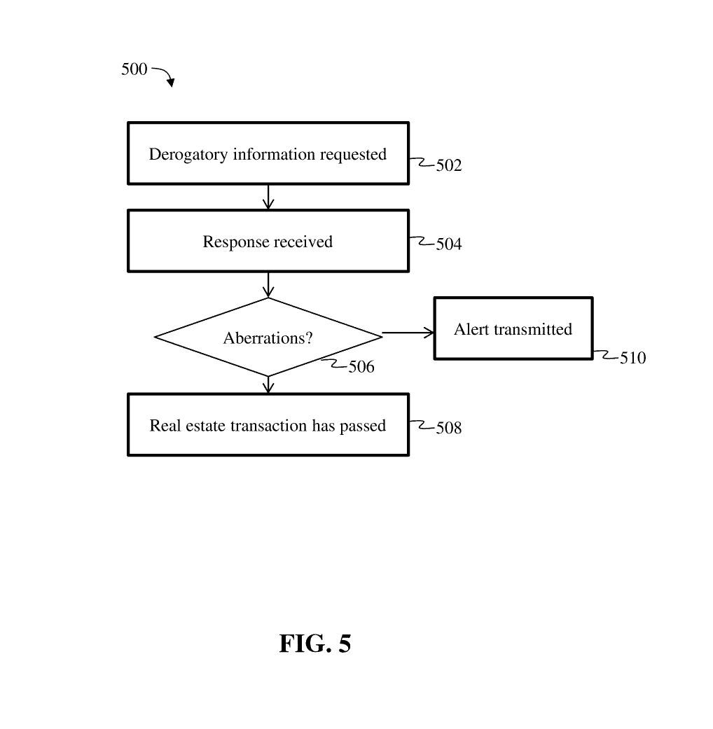

In stage 322, the program logic 150 of server 102 performs a document analysis process, which is described in greater detail below with reference to FIG. 4. In stage 324, the program logic 150 of server 102 performs a derogatory information search, which is described in greater detail below with reference to FIG. 5. In stage 326, the program logic 150 of server 102 determines whether the real estate transaction has passed the inquiries of stages 322 and 324. If the real estate transaction has passed, then control flows to stage 328. Otherwise, control flows to stage 316.

Assuming that the document analysis process of stage 322 and the derogatory information search of stage 324 did not result in any aberrant findings, then in stage 328, the program logic 150 of server 102 stores an indicator (which may be a data structure) that indicates the real estate transaction has been vetted. The indicator may be stored in the one or more records associated with the real estate transaction in the database 104. In lieu of saving the indicator, or in conjunction with this act, the program logic 150 of server 102 may send a message 250 alerting one or more of parties to the real estate transaction that the real estate transaction has been vetted and that the real estate transaction will be moving forward.

It should be noted that the method 300 provides a simplified version of the actions taken by each of the parties to a real estate transaction with regard to server 102. As explained above, the present invention supports the entering of data and the participation of additional parties, such as real estate agents, attorneys, etc. Further, the stage of method 300 need not occur in the exact sequence as stated above. The stages of method 300 may be interchanged and re-arranged in various sequences.

FIG. 4 is a flow chart of a method 400 for performing document examination routines for fraud detection processes for real estate transactions, according to an example embodiment. Note that method 400 provides greater detail about stage 322 of method 300. Although method 400 shows the document examination being performed on one document, a purchase contract, the method 400 can be used on any number of documents used in the real estate transaction process. Method 400 may be implemented using a computing device 600 as described in more detail below with respect to FIG. 6.

In a first stage 402, if a notarization document 212 has been received by server 102 in step 320, then the program logic 150 of server 102 identifies several pieces of data in the document image of the notarization document 212, such as a unique identifier for the buyer 110, a unique identifier for the seller 112, and a purchase price of the real estate interest. Next, in stage 404, the program logic 150 of server 102 determines whether the data read from the document image of the notarization document 212 matches the data read received by server 102 in one or more of 202, 206, 208, 210 214 and/or step 304. For example, the program logic 150 of server 102 may determine whether the unique identifier for the buyer 110, the unique identifier for the seller 112, and the purchase price read from the document image of the notarization document 212 matches the unique identifier for the buyer 110, the unique identifier for the seller 112, and the purchase price read from purchase contract 202 and/or purchase contract 204.

If the program logic 150 of server 102 determines there is a match, then control flows to stage 406. If the program logic 150 of server 102 determines there is no match, then control flows to stage 430.

In stage 406, the program logic 150 of server 102 identifies a purchase price in a document image of the purchase contract 202 and identifies the placement and font of the purchase price in the document image of the purchase contract 202. In stage 408, the program logic 150 of server 102 identifies text surrounding the purchase price in the document image of the purchase contract 202 and identifies the placement and font of the text surrounding the purchase price in the document image of the purchase contract 202.

In one embodiment, before the execution of stages 402, 406 or 408, the program logic 150 of server 102 may perform an OCR process to convert the document being read (such as purchase contract 202) to a character-based document image. Subsequently, the program logic 150 of server 102 may perform a text string search to find the relevant data, such as the purchase price, in the character-based document image, as well as the surrounding text.

In one embodiment of the present invention, the stages 402, 406 or 408 are fully automated and performed by program logic 150 of server 102. In another embodiment of the present invention, the stages 402, 406 or 408 are partially automated and performed by program logic 150 of server 102 in conjunction with the aid of an individual, such as buyer 110. In this embodiment, the individual may specify the area of the document image in which the data being sought, such as the purchase price, is located or may highlight the data being sought in the document image.

Next, in stage 410, the program logic 150 of server 102 determines whether there are any aberrations or differences in the font and placement of the purchase price in comparison to the font and placement of the surrounding text. Examples of aberrations would be differences in font, font spacing or font type, differences in the vertical location of the purchase price and differences in the horizontal location of the purchase price.

If the result of the determination of stage 410 is that no aberrations were found, then control flows to stage 412, wherein the real estate transaction has been deemed to pass the inquiry of method 400. The program logic 150 of server 102 may store an indicator that indicates the real estate transaction has passed the inquiry of method 400. The indicator may be stored in the one or more records associated with the real estate transaction in the database 104. In lieu of saving the indicator, or in conjunction with this act, the program logic 150 of server 102 may send a message 250 alerting one or more of parties to the real estate transaction that the real estate transaction has passed the inquiry of method 400. If the result is that aberrations were in fact found, then control flows to stage 430, wherein an alert is sent to the authority 280.

FIG. 5 is a flow chart of a method 500 for searching derogatory information for fraud detection processes for real estate transactions, according to an example embodiment. Note that method 500 provides greater detail about stage 324 of method 300. Method 500 may be implemented using a computing device 600 as described in more detail below with respect to FIG. 6.

In stage 502, the program logic 150 of server 102 transmits a request to data provider 180 for derogatory data about one or more of the parties to the real estate transaction. The request ma include identifying information for one or more of the parties to the real estate transaction, such as any of the data that may be included in a user record, as defined above. Derogatory data pertains to any negative information about an individual, including a criminal background, evidence of a criminal investigation into the individual, past incarceration, etc.

In step 504, data provider 180 provides a response to server 102, wherein the response may include derogatory data about one or more individuals to the real estate transaction. In stage 506, the program logic 150 of server 102 determines whether the response from the data provider 180 resulted in any aberrant information about one of the parties to the real estate transaction. If the result of the determination is that aberrant information was not received, then control flows to stage 508, wherein the real estate transaction has been deemed to pass the inquiry of method 500. The program logic 150 of server 102 may store an indicator that indicates the real estate transaction has passed the inquiry of method 500. The indicator may be stored in the one or more records associated with the real estate transaction in the database 104. In lieu of saving the indicator, or in conjunction with this act, the program logic 150 of server 102 may send a message 250 alerting one or more of parties to the real estate transaction that the real estate transaction has passed the inquiry of method 500. If the result is that aberrant information was in fact received, then control flows to stage 510, wherein an alert is sent to the authority 280.

FIG. 6 is a block diagram of a system including an example computing device 600 and other computing devices. Consistent with the embodiments described herein, the aforementioned actions performed by client computers 120, 122, by server 102 and the providers 170, 180 may be implemented in a computing device, such as the computing device 600 of FIG. 6. Any suitable combination of hardware, software, or firmware may be used to implement the computing device 600. The aforementioned system, device, and processors are examples and other systems, devices, and processors may comprise the aforementioned computing device. Furthermore, computing device 600 may comprise an operating environment for methods 300, 400 and 500 as described above. Methods 300, 400 and 500 may operate in other environments and are not limited to computing device 600.

With reference to FIG. 6, a system consistent with an embodiment of the invention may include a plurality of computing devices, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination or memory. System memory 604 may include operating system 605, and one or more programming modules 606. Operating system 605, for example, may be suitable for controlling computing device 600's operation. In one embodiment, programming modules 606 may include, for example, a program module 607 for executing the actions of program logic 150. Furthermore, embodiments of the invention may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a camera, a touch input device, etc. Output device(s) 614 such as a display, speakers, a printer, etc. may also be included. The aforementioned devices are only examples, and other devices may be added or substituted.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 may perform processes including, for example, one or more of method 300's, method 400's or method 500's stages as described above. The aforementioned processes are examples, and processing unit 602 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for detecting fraud in a real estate transaction involving a real estate interest, comprising:
receiving, via a communications network, definition data for each of a plurality of parties to the real estate transaction, wherein definition data includes at least a unique identifier for a party;
registering, via the communications network, each of one or more parties of the plurality of parties to the real estate transaction;
receiving, via a communications network, a first transaction data from a first party to the real estate transaction, wherein the first transaction data includes at least a unique identifier for the real estate interest and a first purchase amount for the real estate interest;
receiving, via the communications network, a second transaction data from a second party to the real estate transaction, wherein the second transaction data includes at least the unique identifier for the real estate interest and a second purchase amount for the real estate interest;
comparing the first purchase amount with the second purchase amount;
wherein if the first purchase amount and the second purchase amount are not identical, transmitting a request, over the communications network, to review the real estate transaction;
wherein if certain ones of the plurality of parties do not undergo registering, transmitting a request, over the communications network, for a notarization document associated with the real estate interest;
responsive to transmitting the request for a notarization document, receiving an image of the notarization document associated with the real estate interest, wherein the notarization document includes at least a third purchase amount, a third unique identifier for the first party and a fourth unique identifier for the second party;
comparing the first unique identifier with the third unique identifier, comparing the second unique identifier with the fourth unique identifier, and comparing the first purchase amount with the third purchase amount; and
wherein if the first unique identifier is identical to third unique identifier, the second unique identifier is identical to the fourth unique identifier, and the first purchase amount is identical to the third purchase amount, storing an indicator that the real estate transaction has been vetted.

2. The method of claim 1, wherein a unique identifier for a party includes a text string comprising at least one of a name, address, date of birth, email address and social security number.

3. The method of claim 2, wherein a unique identifier for a real estate interest includes a text string comprising at least one of a property address and a property identification number.

4. The method of claim 3, wherein the step of transmitting a request for a notarization document further comprises:
determining contact information for a notarization entity within a vicinity of the real estate interest; and
transmitting a request, over the communications network, to the notarization entity within a vicinity of the real estate interest, requesting a notarization document associated with the real estate interest.

5. The method of claim 4, wherein the step of receiving an image of the notarization document further comprises:
receiving a Portable Document Format file representing the notarization document associated with the real estate interest.

6. The method of claim 4, wherein the step of comparing the first unique identifier and the second unique identifier further comprises:
performing an optical character recognition process on the image of the notarization document so as to produce a character-based image of the notarization document;
extracting the third unique identifier for the first party, the fourth unique identifier of the second party and the third purchase amount from the character-based image of the notarization document; and
comparing the first unique identifier with the third unique identifier, comparing the second unique identifier with the fourth unique identifier, and comparing the first purchase amount with the third purchase amount.

7. The method of claim 1, further comprising:
wherein if the first unique identifier is identical to third unique identifier, the second unique identifier is identical to the fourth unique identifier, and the first purchase amount is identical to the third purchase amount, transmitting, via the communications network, a message at least to the first party and the second party indicating that the real estate transaction has been vetted.

8. The method of claim 1, further comprising:
wherein if the first purchase amount and the second purchase amount are not identical, transmitting an alert, over the communications network, to an authority, wherein the alert includes at least the first transaction data and the second transaction data.

9. The method of claim 8, further comprising:
wherein if the first unique identifier is not identical to third unique identifier, or the second unique identifier is not identical to the fourth unique identifier, or the first purchase amount is not identical to the third purchase amount, transmitting an alert, over the communications network, to an authority, wherein the alert includes the first transaction data and the second transaction data.

10. The method of claim 1, further comprising:
creating a unique record associated with the definition data, first transaction data, the second transaction data, the image of the notarization document associated with the real estate interest and the indicator.

11. The method of claim 10, wherein the step of storing an indicator further comprises storing in the unique record the indicator that the real estate transaction has been vetted.

12. A computer system, connected to a communications network, for detecting fraud in a real estate transaction involving a real estate interest, the system comprising:
a memory storage;
a network connection device communicatively coupled with the communications network, wherein the network connection device is configured for:
receiving definition data for each of a plurality of parties to the real estate transaction, wherein definition data includes at least a unique identifier for a party;
receiving a first transaction data from a first party to the real estate transaction, wherein the first transaction data includes at least a unique identifier for the real estate interest and a first document image that includes a first purchase amount for the real estate interest; and
receiving a second transaction data from a second party to the real estate transaction, wherein the second transaction data includes at least the unique identifier for the real estate interest and a second document image that includes a second purchase amount for the real estate interest; and
a processing unit coupled to the memory storage, wherein the processing unit is operative for:
registering each of one or more parties of the plurality of parties to the real estate transaction;
extracting the first purchase amount from the first document image and extracting the second purchase amount from the second document image;
comparing the first purchase amount with the second purchase amount;
wherein if the first purchase amount and the second purchase amount are not identical, issuing a command to the network connection device to transmit a request, over the communications network, to review the real estate transaction;
wherein if certain ones of the plurality of parties do not undergo registering, issuing a command to the network connection device to transmit a request, over the communications network, for a notarization document associated with the real estate interest;
responsive to the network connection device transmitting the request for a notarization document, receiving, via the network connection device, an image of the notarization document associated with the real estate interest, wherein the notarization document includes at least a third purchase amount, a third unique identifier for the first party and a fourth unique identifier for the second party;
comparing the first unique identifier with the third unique identifier, comparing the second unique identifier with the fourth unique identifier, and comparing the first purchase amount with the third purchase amount; and
wherein if the first unique identifier is identical to third unique identifier, the second unique identifier is identical to the fourth unique identifier, and the first purchase amount is identical to the third purchase amount, storing an indicator that the real estate transaction has been vetted.

13. The computer system of claim 12, wherein if the first unique identifier is identical to third unique identifier, the second unique identifier is identical to the fourth unique identifier, and the first purchase amount is identical to the third purchase amount, the processing unit is further operative for issuing a command to the network connection device to transmit, via the communications network, a message at least to the first party and the second party indicating that the real estate transaction has been vetted.

14. The computer system of claim 12, wherein if the first purchase amount and the second purchase amount are not identical, the processing unit is further operative for issuing a command to the network connection device to transmit an alert, over the communications network, to an authority, wherein the alert includes the first transaction data and the second transaction data.

15. The computer system of claim 14, wherein if the first unique identifier is not identical to third unique identifier, or the second unique identifier is not identical to the fourth unique identifier, or the first purchase amount is not identical to the third purchase amount, the processing unit is further operative for issuing a command to the network connection device to transmit an alert, over the communications network, to an authority, wherein the alert includes the first transaction data and the second transaction data.

16. The computer system of claim 12, wherein the step of extracting the first purchase amount from the first document image further comprises:
performing an optical character recognition process on the first document image so to produce a character-based image of the first document image.

17. The computer system of claim 16, wherein the step of comparing the first purchase amount with the second purchase amount further comprises:
identifying a font of the first purchase amount in the first document image and a font of surrounding text in the first document image;
identifying a font of the second purchase amount in the second document image and a font of surrounding text in the second document image; and
comparing the font of the first purchase amount in the first document image with the font of surrounding text in the first document image and comparing the font of the second purchase amount in the second document image with the font of surrounding text in the second document image.

18. The computer system of claim 17, wherein the step of extracting the third purchase amount further comprises:
performing an optical character recognition process on the image of the notarization document so to produce a character-based image of the notarization document.

19. The computer system of claim 18, wherein the step of comparing the first unique identifier with the third unique identifier further comprises:
identifying a font of the third purchase amount in the image of the notarization document and a font of surrounding text in the image of the notarization document; and
comparing the font of the third purchase amount in the image of the notarization document with the font of surrounding text in the image of the notarization document.

20. A computer program product for detecting fraud in a real estate transaction involving a real estate interest, the computer program product comprising at least one computer readable storage medium having one or more computer readable program code portions stored therein, said computer readable program code portions comprising:
a first executable portion for receiving, via a communications network, definition data for each of a plurality of parties to the real estate transaction, wherein definition data includes at least a unique identifier for a party;
a second executable portion for registering, via the communications network, each of one or more parties of the plurality of parties to the real estate transaction;
a third executable portion for transmitting a request, over the communications network, for derogatory information pertaining to one or more parties of the plurality of parties based on the definition data;
responsive to transmitting the request, a fourth executable portion for receiving information pertaining to the one or more parties of the plurality of parties;
a fifth executable portion for receiving, via a communications network, a first transaction data from a first party to the real estate transaction, wherein the first transaction data includes at least a unique identifier for the real estate interest and a first purchase amount for the real estate interest;
a sixth executable portion for receiving, via the communications network, a second transaction data from a second party to the real estate transaction, wherein the second transaction data includes at least the unique identifier for the real estate interest and a second purchase amount for the real estate interest;
a seventh executable portion for comparing the first purchase amount with the second purchase amount;
wherein if the first purchase amount and the second purchase amount are not identical or if the information includes derogatory information, an eighth executable portion for transmitting a request, over the communications network, to review the real estate transaction;
wherein if certain ones of the plurality of parties do not undergo registering, a ninth executable portion for transmitting a request, over the communications network, for a notarization document associated with the real estate interest;
responsive to transmitting the request for a notarization document, a tenth executable portion for receiving an image of the notarization document associated with the real estate interest, wherein the notarization document includes at least a third purchase amount, a third unique identifier for the first party and a fourth unique identifier for the second party;
a eleventh executable portion for comparing the first unique identifier with the third unique identifier, comparing the second unique identifier with the fourth unique identifier, and comparing the first purchase amount with the third purchase amount; and
wherein if the first unique identifier is identical to third unique identifier, the second unique identifier is identical to the fourth unique identifier, and the first purchase amount is identical to the third purchase amount, a twelfth executable portion for storing an indicator that the real estate transaction has been vetted.
